(19) United States
(12) Patent Application Publication
(10) Pub. No.: US 2026/0335827 A1
(43) Pub. Date: Oct. 29, 2026

(54) TEMPORALLY MULTI-STAGED BATCH COUNTERFLOW REVERSE OSMOSIS FOR HIGH RECOVERY DESALINATION

(71) Applicant: Purdue Research Foundation, West Lafayette, IN (US)

(72) Inventors: Abhimanyu DAS, West Lafayette, IN (US); David Elan Martin Warsinger, Carmel, IN (US)

(21) Appl. No.: 19/114,566

(22) PCT Filed: Sep. 19, 2023
(86) PCT No.: PCT/US23/74606

§ 371 Date: Mar. 24, 2025

Related U.S. Application Data
(60) Provisional application No. 63/409,030, filed on Sep. 22, 2022.

(51) Int. Cl. B01D 61/02; C02F 1/44; C02F 103/08

(52) U.S. Cl. CPC B01D 61/026; C02F 1/441; B01D 2313/18; B01D 2313/243; B01D 2313/70; B01D 2315/24; B01D 2317/06; C02F 2103/08; C02F 2201/005; C02F 2301/046; C02F 2301/08

(57) ABSTRACT

A temporally multi-staged assembly for reverse osmotically desalinating water, including a feed water source and a batch counterflow reverse osmosis module operationally connected to the water feed source. The batch counterflow reverse osmosis module includes a first high-pressure tank having a first portion and a second portion and a reverse osmosis membrane operationally connected therebetween, a first portion inlet operationally connected to the first portion and a second portion inlet operationally connected to the second portion, a first portion outlet operationally connected to the first portion and a second portion outlet operationally connected to the second portion, a first valve having a first first valve inlet, a second first valve inlet, a first first valve outlet in fluidic communication with the first portion inlet and a second first valve outlet in fluidic communication with the second portion inlet, a high-pressure pump operationally connected to the source and to the first first valve inlet, a second valve having a first second valve inlet in fluidic communication with the first portion outlet and a second second valve inlet in fluidic communication with the second portion outlet and a second valve outlet, a second high-pressure tank having a third portion and a fourth portion and a counterflow reverse osmosis membrane operationally connected therebetween, a third portion inlet operationally connected to the third portion and to the first portion outlet and a fourth portion inlet operationally connected to the fourth portion and to the second portion outlet, a third portion outlet operationally connected to the third portion and to the second portion and a fourth portion outlet operationally connected to the fourth portion, a third valve having a first third valve inlet, a second third valve inlet, a first third valve outlet in fluidic communication with the third portion inlet and a second third valve outlet in fluidic communication with the fourth portion inlet, a third high-pressure tank having a fifth portion and a sixth portion and a batch counterflow reverse osmosis membrane operationally connected therebetween, a fifth portion inlet operationally connected to the fifth portion and to the third portion outlet and a sixth portion inlet operationally connected to the sixth portion, a fifth portion outlet operationally connected to the fifth portion and a sixth portion outlet operationally connected to the second portion inlet and to the fourth portion inlet, a fourth valve having a first fourth valve inlet, a second fourth valve inlet, a first fourth valve outlet in fluidic communication with the fifth portion inlet and a second fourth valve outlet in fluidic communication with the second portion inlet. A plurality or respective diluent tanks are operationally connected to the batch counterflow reverse osmosis module. A circulation pump is operationally connected to the batch counterflow reverse osmosis module and an electronic controller is operationally connected to the respective valves and to the high-pressure pump and to the circulation pump.

### CROSS-REFERENCE TO RELATED APPLICATIONS

This patent application claims priority to PCT Application no. PCT/US23/74606 filed on Sep. 19, 2023 which claims priority to U.S. provisional patent application Ser. No. 63/409,030, filed on Sep. 22, 2022, the entirety of which is incorporated herein by reference.

### BACKGROUND

Water is an increasingly globally scarce natural resource. The demand for freshwater is growing at a rate that can barely be met by its natural supply, leading to acute shortages around the world. The World Resources Institute reports that by 2025, around 3.5 billion people could be affected by water scarcity. Among potential solutions, reverse osmosis (RO) is a membrane separation process that can help mitigate this problem given its high thermodynamic efficiency, compact footprint, and economic scalability. However, current RO technology is limited to seawater salinity and recovery ratios of around 50%, since operating with higher salinities or recoveries would exceed the burst pressure of the membrane (~70 bar). Operation at higher pressures can also cause compaction of the active layer of the membrane with increased propensity for irreversible fouling. Membranes rated for operation at higher pressures have thick support layers, necessary for mechanical strength, but also leading to significant concentration polarization and reduced energy efficiency. Treating high salinity feeds, as such, has been the forte of thermally driven processes which tend to be thermodynamically inefficient but economically feasible given that thermal energy is usually much cheaper than electricity.

Nonetheless, efforts at membrane-based desalination of high salinity feeds have been made with some reported in Table 1. Of these, osmotically assisted reverse osmosis (OARO) or counterflow reverse osmosis (CFRO) is a recent technology that can desalinate high salinity feeds and reach high recoveries while operating at regular RO pressures. In osmotically assisted processes, both sides of the membrane are saline, and the streams are in counterflow to maintain a relatively constant osmotic pressure difference across the membrane. The stream entering the feed side or concentrate side gets concentrated due to permeation. Likewise, the stream on the other side, which is called the diluate side, as the name suggests, gets diluted.

Batch reverse osmosis is a recent process design that closely follows the osmotic pressure of a concentrating feed volume. Batch operation is achieved by recirculating the brine leaving the membrane module back into the feed tank which leads to a gradual increase in tank salinity. A small longitudinal gradient along the membrane module is maintained by having a large cross flow. The energy expenditure exceeds the thermodynamic minimum due to over-pressurization for maintaining a desired flux, salinity elevation at membrane surface due to finite flux and pressure drop in the circulation loop. Non-ideal conditions in the process, pumps and motors also add to the energy consumption. In spite of these losses, batch RO still consumes less energy than continuous or steady state RO for the same capacity, flux and recovery.

A batch RO system can be designed using a high-pressure piston tank that needs to be appropriately sized for a specific recovery. Alternately, a pressure exchanger (PX) may be employed to recover pressure energy from the brine exiting the membrane module and to pressurize the feed entering the module from an atmospheric pressure tank. The PX design brings in flexibility in terms of variable recovery.

Batch RO processes have been shown to be highly energy efficient as they can closely follow the osmotic pressure profile of the feed while maintaining a relatively flat flux profile along the membrane. Based on a similar idea, single stage batch CFRO was introduced in that could concentrate seawater to a recovery of around 62% with a terminal pressure of 70 bar. The working principle of the process has been shown in FIG. 1, where recirculation of the concentrate and diluate streams in their individual tanks allows for a uniform and gradual increase in pressure over time. Thus, there remains a need for a better, more efficient desalination process. The present invention addresses this need.

### SUMMARY

Osmotically assisted reverse osmosis (OARO) or counterflow reverse osmosis (CFRO) are recent RO configurations that use saline streams on both sides of the membrane in counterflow. This reduces the osmotic pressure difference that needs to be overcome for permeation and allows water recovery from high salinity feeds at regular RO pressure. Batch RO is a new, transient RO configuration that closely follows the osmotic pressure profile of the feed and is marked by high energy efficiency. Herein, a transient version of CFRO is extended batch CFRO for high recovery (~84%) desalination of seawater using a temporally multi-staged version of the process. In doing so, the first configuration is introduced to achieve batch CFRO using currently available components, favoring implementation of a pressure exchanger over high pressure tanks. Using a reduced order model, the terminal salinity of the brine leaving the system is calculated to be 194.35 g/kg. One interesting feature of this new configuration is that it is multi-staged in time rather than space and as such uses the same hollow fiber membrane module for the different stages so as to increase efficiency and reduce the component (pumps and pressure exchangers) count of the process. The brine produced in each stage is stored in inexpensive atmospheric pressure tanks. This is in contrast with other multi-stage processes where the number of flow devices usually scale with the number of stages needed for higher recovery and usually leads to higher cost. The specific energy consumption breakdown of the process shows that around 34% of the energy is consumed to overcome the flow resistance in the hollow fibers.

In one embodiment, batch reverse osmosis (RO) is a desalination process that can follow the osmotic pressure of gradually concentrating feed to achieve high energy efficiency. Its limitation of treating high salinity (>7% wt.) feed is overcome by making both sides of the membrane saline. This reduces the osmotic pressure difference across the active layer of the membrane and is the engine behind counterflow RO. To increase the recovery of batch counterflow RO, a temporally multi-staged process is employed. A pressure exchanger design allows utilization of atmospheric pressure tanks to gradually concentrate and/or dilute the two streams. To achieve temporal multi-staging, multiple batches are run using the same membrane but varying salinities, thus ensuring that the volume and salinity of the diluting feed at the end of each stage stabilize to a cyclic steady state. The diluate (diluted feed) produced at the end of the first stage offsets the feed requirement of the seawater RO system feeding the counterflow RO system and substantially increases overall recovery. Using an unsteady nodal model that captures internal and external concentration polarization, we predict a 4.24 kWh/m³ specific energy consumption, operating at 84.39% volumetric recovery and 2.12 LMH time averaged counterflow RO flux. The second law efficiency of the system is calculated as 41.8%.

| Nomenclature | | |
|---|---|---|
| Symbol | Description | Units |
| A | Area | m2 |
| Aw | Water permeability coefficient | LMH/bar |
| B | salt permeability coefficient | LMH |
| C | Salinity | g/kg |
| • C | Rate of change of salinity | g/kg/s |
| D | Diffusion coefficient of salt | m2/s |
| | in water | |
| d | Diameter | m |
| · E | Power | KW |
| Js | Salt flux | g/m2/s |
| Jwv | Volumetric water flux | LMH |
| Jw | Water flux | kg/m2/s |
| L_{fiber} | Fiber length | m |
| m · ₛ | Salt transport rate across | g/s |
| | membrane | |
| m · ₛₒₗ | Solution transport rate across | kg/s |
| | membrane | |
| N_{fiber} | Number of hollow fibers in | — |
| | the module | |
| N_{void} | Number of void regions | — |
| P_{HPP} | HPP outlet pressure | bar |
| r | Radius | m |
| r_{a,o} | Auxiliary outer radius of | m |
| | annulus | |
| Re | Reynolds number | — |
| RR | Recovery ratio | — |
| RRₚₐₛₛ | Recovery ratio per pass | — |
| S | Structural parameter | m |
| Sc | Schmidt number | — |
| SEC | Specific energy consumption | kWh/m3 |
| Sh | Sherwood number | — |
| t | Time | s |
| u | Axial velocity | m/s |
| û | Average axial velocity | m/s |
| V | Volume | m³ |
| ·V | Volumetric flow rate | m³/s |
| ΔP | Trans-membrane pressure | bar |
| ΔP_{c} | Pressure drop in the | bar |
| | concentrate side | |
| ΔP_{d} | Pressure drop in the diluate | bar |
| | side | |
| Δπ | Trans-membrane osmotic | bar |
| | pressure | |
| δ | Boundary layer thickness | m |
| η | Isentropic efficiency | — |
| v | Kinematic viscosity | m²/s |
| π | Osmotic pressure | bar |
| p | Density | kg/m³ |
| pw | Pure water density | kg/m³ |

| | Description |
|---|---|
| Abbreviation | |
| BCFRO | Batch counterflow reverse osmosis |
| CCP | Concentrate circulation pump |
| CFRO | Counterflow reverse osmosis |
| COMRO | cascading osmotically mediated |
| | reverse osmosis |
| DCP | Diluate circulation pump |
| ERD | Energy recovery device |
| HPP | High-pressure pump |
| LMH | L/m2/h |
| OARO | Osmotically assisted reverse osmosis |
| PX | Pressure exchanger |
| RO | Reverse osmosis |
| ZLD | Zero-liquid discharge |
| Subscripts | |
| b | Bulk |
| bl | Boundary layer |
| C | Concentrate |
| d | Diluate |
| eff | Effective inside the support layer |
| fiber | Fiber |
| i | Interior (bore side) |
| k | Index of the temporal stage |
| in | Entering membrane |
| H | Hydraulic |
| initial | Initial |
| m | Membrane |
| max | Maximum |
| mod | Module |
| o | Exterior (shell side) |
| out | Exiting membrane |
| s | Salt |
| sol | Solution |
| sup | Active-support layer interface |
| tank | Tank |
| v | Volumetric |
| void | Void space between the fibers |
| w | Water |

### BRIEF DESCRIPTION OF THE DRAWINGS

FIG. 1 is a schematic drawing of a first embodiment of the present novel technology, a temporally multi-staged batch CFRO system.

FIGS. 2A and 2B are schematic cross-sectional views of a hollow fiber desalination membrane as used in the system of FIG. 1.

FIG. 3A graphically represents salinity as a function of flux for the system of FIG. 1.

FIG. 3B graphically represents pressure as a function of flux for the system of FIG. 1.

FIG. 4 graphically represents the relationship between stage and specific energy consumption for the system of FIG. 1.

FIG. 5A graphically represents tank salinity as a function of time for the system of FIG. 1.

FIG. 5B graphically represents tank volume as a function of time for the system of FIG. 1.

FIG. 6A graphically represents trans-membrane salinity as a function of time for the system of FIG. 1.

FIG. 6B graphically represents trans-membrane volume as a function of time for the system of FIG. 1.

FIG. 7A graphically represents concentrate inlet pressure as a function of time for the system of FIG. 1.

FIG. 7B graphically represents pressure differential as a function of time for the system of FIG. 1.

FIG. 8 is a schematic drawing of a second embodiment of the present novel technology, a temporally multi-staged batch CFRO system.

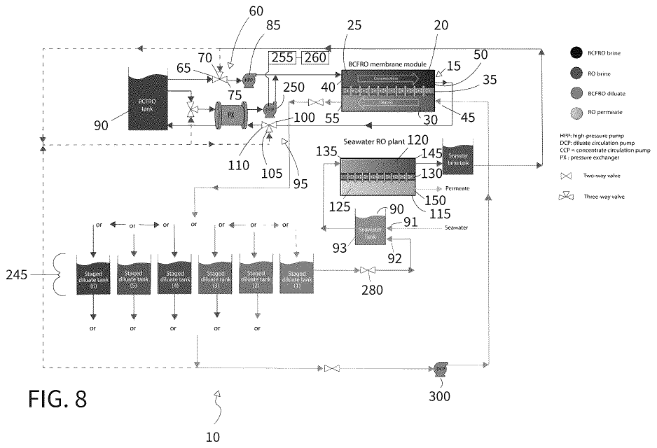

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated device, and such further applications of the principles of the disclosure as illustrated therein being contemplated as would normally occur to one skilled in the art to which the disclosure relates. At least one embodiment of the present disclosure will be described and shown, and this application may show and/or describe other embodiments of the present disclosure. It is understood that any reference to “the disclosure” is a reference to an embodiment of a family of disclosures, with no single embodiment including an apparatus, process, or composition that should be included in all embodiments, unless otherwise stated. Further, although there may be discussion with regards to “advantages” provided by some embodiments of the present disclosure, it is understood that yet other embodiments may not include those same advantages, or may include yet different advantages. Any advantages described herein are not to be construed as limiting to any of the claims. The usage of words indicating preference, such as “preferably,” refers to features and aspects that are present in at least one embodiment, but which are optional for some embodiments.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise explicitly noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

What will be shown and described herein, along with various embodiments of the present disclosure, is discussion of one or more tests that were performed. It is understood that such examples are by way of example only and are not to be construed as being limitations on any embodiment of the present disclosure. Further, it is understood that embodiments of the present disclosure are not necessarily limited to or described by the mathematical analysis presented herein.

Various references may be made to one or more processes, algorithms, operational methods, or logic, accompanied by a diagram showing such organized in a particular sequence. It is understood that the order of such a sequence is by example only, and is not intended to be limiting on any embodiment of the disclosure.

This document may use different words to describe the same element number, or to refer to an element number in a specific family of features. It is understood that such multiple usage is not intended to provide a redefinition of any language herein. It is understood that such words demonstrate that the particular feature can be considered in various linguistical ways, such ways not necessarily being additive or exclusive.

What will be shown and described herein are one or more functional relationships among variables. Specific nomenclature for the variables may be provided, although some relationships may include variables that will be recognized by persons of ordinary skill in the art for their meaning. For example, “t” could be representative of temperature or time, as would be readily apparent by their usage. However, it is further recognized that such functional relationships can be expressed in a variety of equivalents using standard techniques of mathematical analysis (for instance, the relationship F=ma is equivalent to the relationship F/a=m). Further, in those embodiments in which functional relationships are implemented in an algorithm or computer software, it is understood that an algorithm-implemented variable can correspond to a variable shown herein, with this correspondence including a scaling factor, control system gain, noise filter, or the like.

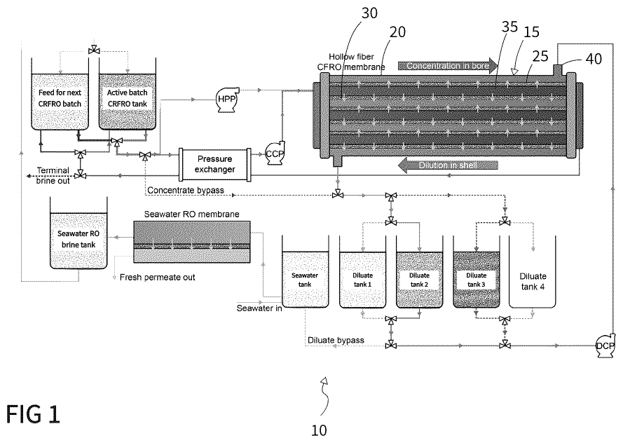

As illustrated in FIGS. 1-5, batch CFRO is extended herein to an even higher overall recovery (~84% of seawater) and introduces a temporally multi-stage batch process. In a first embodiment, the same membrane module is employed across different stages, requiring only one set of flow devices, such as pumps, pressure exchangers, and/or the like. Brine concentrate produced in one stage is used as the feed for the next stage, while the diluate produced in one stage is used in the next cycle for the previous stage. The system uses a well-designed valving system and an atmospheric pressure storage tank for each stage, which are relatively less expensive than spatially multi-staged processes requiring flow devices for each stage.

TABLE 1
Comparison between high salinity and high recovery reverse
osmosis desalination methods (adapted and modified
from [6])

| | | | | Number |
|---|---|---|---|---|
| | | | | of CFRO |
| | Feed | Re- | SEC | stages \| |
| | salinity | covery | (kWh/ | pumps \| |
| Configuration | (g/kg) | (%) | m³) | ERDs |
| OARO[3] | 6 | 50 | 3.7 | 3 \| 3 \| 3 |
| | 0 | | 0 | |
| COMRO[7] | 7 | 50 | 3.1 | 4 \| 4 \|1 |
| | 0 | | 6 | |
| Split feed | 3 | 81 | 3.9 | 5 \| 5 \| 4 |
| CFRO[4] | 5 | | 0 | |
| BCFRO-BRO[6] | 3 | 62 | 1.9 | 1 \| 4 \| 0 |
| | 5 | | 5 | |
| Multi-stage batch | 3 | 84. | 4.2 | 1* \| 3 \| 1 |
| CFRO (this work) | 5 | 39 | 4 | |

*The single stages were run at 4 cycles to achieve this recovery

The recirculation of the concentrate and diluate streams leads to a gradual change in salinity over time and consequently an osmotic pressure difference to be overcome to cause permeation.

### Process Design

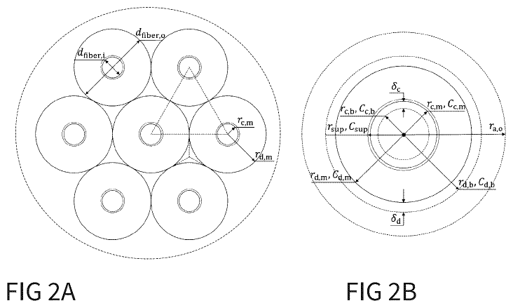

The philosophy behind multi-stage batch CFRO is to gradually concentrate the feed over time using the same membrane module (see FIG. 2). The construction of a such a system involves a pressure vessel that can house multiple membrane elements, a high-pressure pump for setting the flux, circulation pumps for maintaining cross flow over the membrane surface and an energy recovery device (ERD) or pressure exchanger (PX) to recover energy from the concentrated feed (concentrate) exiting the membrane module. In regular batch CFRO, two tanks are additionally needed, one for each side of the membrane for recirculation of the streams. The size of the respective tanks dictates the rate at which salinity of the tanks change over time and hence the overall process dynamics. The tanks can be either high-pressure tanks for which a pressure exchanger is not needed, or atmospheric pressure tanks that benefit from the use of a pressure exchanger. In multi-stage batch CFRO, the concentrate produced in one stage is used as the feed for the next stage. While the same concentrate tank can be used for the different stages, the diluate produced in each stage is typically stored so that it can be used in the next cycle, but for the previous stage. As such, a tank is typically provided for each stage. These tanks are atmospheric pressure tanks and as such only need appropriate valving to connect to the diluate side of the membrane module.

Some of the salient features of the process design are listed below:

1. The system is fed by seawater RO brine which has a salinity of ~70 g/kg (50% recovery). (see FIG. 2).
2. As permeation and recirculation happen in each stage, the salinity of the concentrate increases while that of the diluate decreases. This implies an increase in osmotic pressure difference across the membrane and consequently the applied pressure to maintain a certain flux. Increasing concentration for a stage is terminated when the applied pressure reaches a predetermined threshold value, usually a value close to the theoretical burst pressure of the membrane.
3. The diluate produced in one stage is typically not used immediately. The initial volume of diluate in each stage is chosen so that the salinity of the diluate at the end of the stage is equal to the salinity of the feed in the previous stage. Hence, the diluate is typically be stored so that it is available for use in the next cycle. Therefore, small atmospheric tanks are typically provided for each stage, at each of these salinities (see FIG. 2).
4. Typically, only one of the diluate tanks is used in a stage while the other tanks store diluate from other stages. Likewise, only one of the two feed tanks is used in a cycle while the other tank that has the terminal concentrate (brine) from the last stage of the previous cycle is drained and filled with fresh feed.
5. Additional recovery is driven by the diluate produced in the first stage. As mentioned above, the initial diluate volume is set so that the salinity of the diluate is close to that of seawater. Consequently, this reduces the amount sweater brine that needs to be fed to the system and in turn increases overall recovery.
6. The salinity of the diluate stored in each tank will change over the cycles in a cyclic manner. This is because each diluate tank will be eventually diluted to seawater salinity after which it will be emptied and fed back to the seawater RO plant.

Temporally multi-staged batch CFRO is realized by connecting each side of an RO membrane to one or more recirculation tanks. The side of the membrane that loses water is called the concentrate side while the other side gaining water is called the diluate side. In this embodiment a pressure exchanger design is used and hence the recirculation tanks are maintained at atmospheric pressure. Each stage operates in the same way as single-stage batch CFRO starting with the same concentrate and diluate salinity. The difference lies in the way the diluate is processed in each stage. For single-stage batch CFRO that dewaters seawater RO brine, the diluate produced is at seawater salinity and is used to increase the recovery of the combined RO-CFRO system.

A multi-stage process does the same for its first stage; however, for subsequent stages in time, the saline diluate produced is not directly dewatered. Notably, if the salinity of the diluate at the end of a stage is the same as the feed salinity of the previous stage, the produced diluate can be cycled back as the starting diluate volume for the previous stage in the next batch. A batch here defines a set of temporal stages that complete a cycle. By applying conservation of mass to water and salt content between the beginning and end of each stage, permeation volumes that balance the diluate volumes between stages and across batches can be computed. The water flux for each stage can then be chosen so as to not exceed the burst pressure of the membrane. A higher flux implies faster cycle time but may cause the applied pressure to rise too quickly before reaching the desired diluate salinity. Herein, one can arrive at the initial concentrate and diluate tank volumes and set of fluxes that achieve a desired overall water recovery.

In operation, a combined RO and multi-stage batch CFRO system takes in seawater and produces a highly concentrated brine and freshwater permeate. Diluate produced at the end of the first stage, roughly at seawater salinity, is transferred to the seawater tank via the diluate bypass. At the end of a batch, the terminal brine is discarded by opening the flush valve. To help with quick flushing, a set of two concentrate tanks are used: while one tank is being used for feed concentration, the other tank is filled with RO brine to be used in the next batch. It should be noted that none of the temporal stages produce the diluate required for the last stage. Hence, a part of the concentrate volume is used as the starting diluate volume in the last stage, facilitated by the bypass valve before the pressure exchanger. The empty diluate tank receives the concentrate and is used for the last stage.

Diluate produced in the intermediate stages are internally cycled and hence do not accumulate as final outputs at the end of a batch. The salinity of diluate in a tank changes between stages and batches (set of stages) so that the process can run in a cyclic manner. The diluate tanks, as such, are typically uniformly sized for the largest volume and are connected to each other in fluidic communication. While the diluate side of the membrane benefits from flushing at the end of each stage, the concentrate side is typically flushed only after a batch is complete. Hence, with the aforementioned conditions, energy efficient, high recovery RO can be achieved in an internally unsteady but cyclically steady process.

### Methodology

A reduced order nodal model for batch CFRO was used to capture the dynamics of the process. The primary result of this model is the time profile of salinity on either side of the membrane both in bulk flow and at the membrane surface. For each stage, the water flux across the membrane dictates the high-pressure pump flow rate, while the circulation pumps on the concentrate and diluate sides are held constant at their rated flow rates. This approach was used because high-pressure pumps usually have a high isentropic efficiency while circulation pumps usually perform poorly away from their operating point. The osmotic pressure difference associated with the salinity and flux profiles is used to calculate the required pressure, which in turn can be used to calculate power requirements. It should be noted here that flux, salinity, and pressure are coupled quantities and need to be solved for simultaneously. We consider a single membrane for our analysis. However, the same can be easily extended to a multi-membrane train.

### Dynamics

Assuming negligible volume change due to mixing and unsaturated solutions, the volumetric flow rate of the concentrate and diluate streams satisfy

\dot{V}_{c,out}=\dot{V}_{c,in}−\dot{V}ₚ

\dot{V}_{d,out}=\dot{V}_{d,in}+\dot{V}ₚ

Here,

$${\dot{V}}_{p} [ \frac{{m}^{3}}{s} ]$$

is the water permeation rate across the membrane, \dot{V}_{c,in} and \dot{V}_{c,out} are the volume flow rate of the concentrate streams entering and leaving the membrane module respectively. The nomenclature is same for the diluate side, denoted by subscript ‘d’.

Representing the salinity of each feed channel in the membrane modally by the average outlet salinity, conservation of mass of salt on either side of the membrane can be written as

$$\frac{\partial ρ}{\partial C} {\vert}_{{C}_{c , out} ( t )} {\dot{C}}_{c , out} ( t ) {V}_{mem , c} {C}_{c , out} ( t ) + {ρ}_{c , out} {V}_{mem , c} {\dot{C}}_{c , out} ( t ) = {ρ}_{c , in} {\dot{V}}_{c , in} {C}_{c , in} ( t ) - {ρ}_{c , out} {\dot{V}}_{c , out} {C}_{c , out} ( t ) - {\dot{m}}_{s} ( t ) \qquad ( 1 )$$

$$\frac{\partial ρ}{\partial C} {\vert}_{{C}_{d , out} ( t )} {\dot{C}}_{d , out} ( t ) {V}_{mem , d} {C}_{d , out} ( t ) + {ρ}_{d , out} {V}_{mem , d} {\dot{C}}_{d , out} ( t ) = {ρ}_{d , in} {\dot{V}}_{d , in} {C}_{d , in} ( t ) - {ρ}_{d , out} {\dot{V}}_{d , out} {C}_{d , out} ( t ) - {\dot{m}}_{s} ( t ) \qquad ( 2 )$$

where

$${\dot{C}}_{c , out} [ \frac{g}{kg - s} ]$$

is the instantaneous rate of change of outlet concentrate salinity

$${C}_{c , out} [ \frac{g}{kg} ]$$

at time t with C_{c,in} being the inlet salinity. ρ_{c,in} and

$${ρ}_{c , out} [ \frac{kg}{{m}^{3}} ]$$

are respectively, the density of the inlet and outlet concentrate streams evaluated as a function of salinity [12]. V_{mem,c} [m³] is the concentrate side feed channel volume, while

$${\dot{m}}_{s} [ \frac{g}{s} ]$$

is the salt transport rate across the membrane since salt rejection is not perfect. Again, terms for the diluate side are denoted by subscript ‘d’.

Streams on both sides of the membrane are recirculated via individual atmospheric pressure tanks, with the tank outlet stream being the module inlet, and vice versa. Conservation of mass of salt in the tanks, neglecting the volume of the connecting pipes, can likewise be written as

$$\frac{\partial ρ}{\partial C} {\vert}_{{C}_{c , in} ( t )} {\dot{C}}_{c , in} ( t ) {V}_{tank , c} {C}_{c , in} ( t ) + {ρ}_{c , in} {\dot{V}}_{tank , c} {C}_{c , in} ( t ) + {ρ}_{c , in} {V}_{tank , c} ( t ) {\dot{C}}_{c , in} ( t ) = {ρ}_{c , out} {\dot{V}}_{c , out} {C}_{c , out} ( t ) - {ρ}_{c , in} {\dot{V}}_{c , in} {C}_{c , in} ( t ) \qquad ( 3 )$$

V_{tank,c} is the instantaneous volume of concentrating feed in the concentrate tank while

$${\dot{V}}_{tank , c} [ \frac{{m}^{3}}{s} ]$$

is its rate of change given as

\dot{V}_{tank,c}=−\dot{V}ₚ

Similarly, for the diluate side,

$$\frac{\partial ρ}{\partial C} {\vert}_{{C}_{d , in} ( t )} {\dot{C}}_{d , in} ( t ) {V}_{tank , d} {C}_{d , in} ( t ) + {ρ}_{d , in} {\dot{V}}_{tank , d} {C}_{d , in} ( t ) + {ρ}_{d , in} {V}_{tank , d} ( t ) {\dot{C}}_{d , in} ( t ) = {ρ}_{d , out} {\dot{V}}_{d , out} {C}_{d , out} ( t ) - {ρ}_{d , in} {\dot{V}}_{d , in} {C}_{d , in} ( t ) {\dot{V}}_{tank , d} = {\dot{V}}_{p} \qquad ( 4 )$$

The water permeation rate is directly controlled by the high-pressure pump. The concentrate and diluate circulation pumps control the flow rate of concentrate and diluate streams, exiting and entering the membrane module respectively. Hence,

\dot{V}ₚ=\dot{V}_{HPP}

\dot{V}_{c,out}=\dot{V}_{CCP}

\dot{V}_{d,in}=\dot{V}_{DCP}

with \dot{V}_{HPP}, \dot{V}_{CCP} and

$${\dot{V}}_{DCP} [ \frac{{m}^{3}}{s} ]$$

being the volumetric flow rate through the high-pressure, concentrate circulation and diluate circulation pumps. Let J_{wv}[LMH] be the operating volumetric flux and Aₘₑₘ [m²] be the total membrane area based on the inner diameter of the fiber d_{fiber,i} [m], then

$${V}_{HPP} = {J}_{wv} {A}_{mem} [ \frac{1 {m}^{3}}{1000 L} ] [ \frac{1 h}{3600 s} ]$$

Also, the volumetric flow rate at the module inlet is related to the permeation rate via the instantaneous recovery ratio or recovery ratio per pass RRₚₐₛₛ[−] defined as

$${RR}_{pass} = \frac{{\dot{V}}_{p}}{{\dot{V}}_{c , in}} = \frac{{\dot{V}}_{HPP}}{{\dot{V}}_{HPP} + {\dot{V}}_{CCP}}$$

As stated previously, the circulation pump flow rates are typically held constant across stages which implies that RRₚₐₛₛ will change if the operating flux is different between stages. As such, we set RRₚₐₛₛ only for the first stage which has the highest flux. The proceeding stages will have a lower value of RRₚₐₛₛ which can be helpful with increased concentration polarization at elevated salinities. Although the diluate pump flow rate \dot{V}_{DCP}=\dot{V}_{CCP} are set, such may be optimized to reduce energy consumption.

### Hollow Fiber Membrane Geometry

In this embodiment, hollow fiber membranes in which the concentrate flows through the fibers (bore side) and the diluate flows in the void space (shell side) are considered. This flow configuration is informed by the recent developments in hollow fiber membranes that are rated for high pressure on the fiber side. Moreover, it is actually possible to maintain counterflow in hollow fiber membranes, as opposed to spiral wound membranes where the flow has both axial and angular components.

If hexagonal close packing (highest packing efficiency arrangement) is assumed for the hollow fibers as shown in FIG. 2 left, each void of cross-sectional area A_{void} [m²] is shared by 3 fibers, while each fiber is surrounded by 6 voids. This implies the existence of a pair of voids per fiber in an infinite fiber arrangement. For simplifying the analysis, the void space between the hollow fibers can be converted to effective annular regions. Therefore, the effective diluate flow area per fiber Aa can be calculated as

$${A}_{d} = 6 \times \frac{1}{3} {A}_{void} = 2 {A}_{void} = π ( {r}_{a , o}^{2} - {r}_{d , m}^{2} )$$

Here, r_{d,m} [m] denotes the radial distance of the membrane surface from the fiber axis on the diluate side, while r_{a,o} [m] is the auxiliary outer radius of the said annulus. In the following sections, the subscripts ‘c’, ‘d’, ‘b’, ‘m’ and ‘sup’ denote the concentrate side, diluate side, bulk flow, membrane surface, and interface between the active and support layers, respectively. The inner and outer surfaces of the hollow fiber lie at radial distances r_{c,m} and r_{d,m} respectively.
A_{void} can be calculated from the module shell diameter d_{mod} [m] by first calculating the module cross sectional area A_{mod} and plugging in

$${A}_{mod} = π \frac{{d}_{mod}^{2}}{4} = {N}_{fiber} {A}_{fiber , o} + {N}_{void} {A}_{void}$$

where N_{fiber} is the number of hollow fibers in the module and A_{fiber,o} is the fiber cross-sectional area based on its outer diameter d_{fiber,o} [m] with N_{void}≈2N_{fiber}. For the flow configuration in our analysis, membrane area is based on the fiber inner diameter.

### Concentration Polarization

External concentration polarization on the membrane surfaces and internal concentration polarization in the support layer of the membrane primarily depend on the instantaneous bulk stream salinities, operating flux and membrane properties. Salinities needed to compute the osmotic pressure that needs to be exceeded for permeation are the ones at the active layer surface on the concentrate side and at the interface between the active layer and the support layer. Calculating the spatio-temporal salinity profiles requires solving the unsteady transport equation. However, such an approach is not practical for iterative simulations necessitating simplifications or approximate solutions.

Since batch processes are characterized by small salinity gradients along the longitudinal flow direction, one can abstract away the same to a single node and solve for the salinity profile only in the transverse direction. To do so, we use the steady convection-diffusion equation, which is a widely used simplification for batch RO. This may not be very accurate, as it implies instantaneous stabilization of the transverse salinity profile. Nonetheless, it can help us gain a decent understanding of the overall process dynamics that happen at relatively longer time scales.

The convection-diffusion equation in Cartesian coordinates can be written in its mass-based form for cylindrical coordinates as

$${\dot{m}}_{s} = C ( r ) {\dot{m}}_{sol} - 2 π {rL}_{fiber} {ρ}_{sol} D \frac{dC ( r )}{dr} \qquad ( 5 )$$

### Here,

$${m}_{s} [ \frac{g}{s} ] and {m}_{sol} [ \frac{kg}{s} ]$$

are the radial mass flow rates of salt and solution respectively, C is salinity at a radial distance r [m], L_{fiber} [m] is fiber length, ρₛₒₗ is solution density, and

$$D [ \frac{{m}^{2}}{s} ]$$

is the diffusion coefficient of salt in water. The values of ρₛₒₗ and D vary depending on where Equation 5 is solved: concentrate feed channel, support layer or diluate feed channel, and are evaluated as functions of salinity.
Normalizing the mass flow rates to water flux

$${J}_{w} [ \frac{kg}{{m}^{2} - s} ]$$

and salt flux

$${J}_{w} [ \frac{g}{{m}^{2} - s} ]$$

at the membrane surface on concentrate side (r=r_{c,m}), and assuming Jₛ<<J_{w}, Equation 5 can be written as

$$2 π {r}_{c , m} {L}_{fiber} {J}_{s} = 2 π {r}_{c , m} {L}_{fiber} C ( r ) ( {J}_{w} + {J}_{s} ) - 2 π {rL}_{fiber} {ρ}_{sol} D \frac{dC ( r )}{dr}$$

$$or$$

$${J}_{s} = C ( r ) {J}_{w} - {ρ}_{sol} D \frac{r}{{r}_{c , m}} \frac{dC ( r )}{dr}$$

which can be solved to obtain a relationship between salinities at r₁ and r₂ as

$$\frac{{J}_{w} C ( {r}_{2} ) - {J}_{s}}{{J}_{w} C ( {r}_{1} ) - {J}_{s}} = {( \frac{{r}_{2}}{{r}_{1}} )}^{\frac{{J}_{w} {r}_{c , m}}{{ρ}_{sol} D}} \qquad ( 6 )$$

Equation 6 can be written in the concentrate side boundary layer to find the salinity profile C_{c,bl} as

$$\frac{{J}_{w} {C}_{c , bl} ( r ) - {J}_{s}}{{J}_{w} {C}_{c , b} - {J}_{s}} = {( \frac{r}{{r}_{c , b}} )}^{\frac{{J}_{w} {r}_{c , m}}{{ρ}_{c , out} {D}_{c , out}}} , {r}_{c , b} \leq r \leq {r}_{c , m} \qquad ( 7 )$$

where C_{c,b} is the concentrate side bulk salinity at a radial distance r_{c,b} and D_{c,out} is the diffusion coefficient evaluated at C_{c,out}. The boundary layer thickness δ_{c} [m] connects r_{c,b} and the radial distance of membrane surface on the concentrate r_{c,m} side via

r_{c,b}=r_{c,m}−δ_{c} (8)

The salinity at the concentrate side membrane surface is calculated by substituting r=r_{c,m} in Equation 7 as

$$\frac{{J}_{w} {C}_{c , m} ( r ) - {J}_{s}}{{J}_{w} {C}_{c , b} - {J}_{s}} = {( \frac{{r}_{c , m}}{{r}_{c , b}} )}^{\frac{{J}_{w} {r}_{c , m}}{{ρ}_{c , out} {D}_{c , out}}}$$

Likewise, on the diluate side, Equation 6 can be written with the same nomenclature as

$$\frac{{J}_{w} {C}_{d , bl} ( r ) - {J}_{s}}{{J}_{w} {C}_{d , b} - {J}_{s}} = {( \frac{r}{{r}_{d , b}} )}^{\frac{{J}_{w} {r}_{c , m}}{{ρ}_{d , out} {D}_{d , out}}} , {r}_{d , m} \leq r \leq {r}_{d , b} \qquad ( 9 )$$

r_{d,b}=r_{d,m}+δ_{d} (10)

Similarly, internal concentration polarization in the support layer can be quantified as

$$\frac{{J}_{w} {C}_{sup} - {J}_{s}}{{J}_{w} {C}_{d , m} - {J}_{s}} = {( \frac{{r}_{sup}}{{r}_{d , m}} )}^{\frac{{J}_{w} {r}_{c , m}}{{ρ}_{d , out} {D}_{eff}}}$$

For computational simplicity, we approximate the solution density in the support layer to be ρ_{c,out}. D_{eff} is the effective diffusion coefficient in the support layer which depends on material tortuosity and porosity. The active layer is very thin compared to other membrane dimensions and hence, rₛᵤₚ≈r_{c,m}. C_{d,m} can be obtained from Equation 9 by plugging r=r_{d,m} to yield

$$\frac{{J}_{w} {C}_{d , m} - {J}_{s}}{{J}_{w} {C}_{d , b} - {J}_{s}} = {( \frac{{r}_{d , m}}{{r}_{d , b}} )}^{\frac{{J}_{w} {r}_{c , m}}{{ρ}_{d , out} {D}_{d , out}}}$$

while D_{eff} can be calculated based on support layer thickness and structural parameter S [m] as

$${D}_{e f f} = {D}_{d , out} \frac{{r}_{d , m} - {r}_{c , m}}{S}$$

Again, we approximate the diffusion coefficient in the support layer, if it were completely liquid, with D_{d,out}. Finally, the membrane salt permeability coefficient B[LMH] connects the salt flux and salinity difference across the active layer as

$${J}_{s} \approx B ( {ρ}_{c , out} {C}_{c , m} - {ρ}_{d , out} {C}_{sup} ) [ \frac{1 {m}^{3}}{1000 L} ] [ \frac{1 h}{3600 s} ]$$

The boundary layer thickness δ_{c} and δ_{d} used in Equations 8 and 10 can be obtained from correlations that relate the non-dimensional Reynolds, Schmidt and Sherwood numbers. We first compute an average velocity in the feed channel to calculate Reynolds number using

$${\overline{u}}_{c} {N}_{f iber} {A}_{f i b e r , i} = \frac{{\dot{V}}_{c , i n} + {\dot{V}}_{c , out}}{2}$$

$${\overline{u}}_{d} {N}_{void} {A}_{void} = \frac{{\dot{V}}_{d , i n} + {\dot{V}}_{d , out}}{2}$$

Here, A_{fiber,i} [m²] is the fiber cross-sectional area based on its inner diameter d_{fiber,i} with ū_{c} and

$${\overline{u}}_{d} [ \frac{m}{s} ]$$

being the average axial velocities in the respective feed channels.
The Reynolds number based on the hydraulic diameter of the concentrate feed channel is then calculated as

$$R {e}_{c} = \frac{{\overline{u}}_{c} {d}_{H , c}}{{v}_{c , out}}$$

with

$${ν}_{c , o u t} [ \frac{{m}^{2}}{s} ]$$

being the kinematic viscosity of the concentrate stream evaluated at its outlet salinity C_{c,out} [12]. Similarly, Re_{d} can be calculated for the diluate side. For the concentrate side, the hydraulic diameter is simply the fiber internal diameter d_{H,c}=d_{fiber,i}, while for the diluate side

$${d}_{H , d} = \frac{4 {N}_{v o i d} {A}_{v o i d}}{π {d}_{m o d} + {N}_{fiber} π {d}_{fiber , o}}$$

Schmidt number for the concentrate stream is then calculated as

$${Sc}_{c} = \frac{{ν}_{c , out}}{{D}_{c , out}}$$

For the diluate side, Schmidt number Sc_{d} is determined similarly. With Re and Sc estimated, Sherwood number can be calculated using correlations based on hydraulic diameter, under laminar flow conditions for the bore (concentrate) [36] and shell (diluate) sides as listed below

$$S {h}_{c} = 1.62 R {e}_{c}^{0.33} S {{c}_{c}^{0.33} ( \frac{{d}_{H , c}}{{L}_{fiber}} )}^{0.33}$$

$$S {h}_{d} = 0.048 R {e}_{d}^{0.6} S {c}_{d}^{0.33}$$

δ_{c} and δ_{d} can finally be determined from Sh_{c} and Sh_{d} as

$${δ}_{c} = min ( \frac{{d}_{H , c}}{S {h}_{c}} , {r}_{c , m} )$$

$${δ}_{d} = min ( \frac{{d}_{H , d}}{S {h}_{d}} , {r}_{a , o} - {r}_{d , m} )$$

### Average Outlet Salinity

The next step is to relate the average outlet salinities in Equations 1, 2, 3 and 4 with the boundary layer profiles in Equations 7 and 9. To do so, we assume fully developed, laminar velocity profiles in the feed channels. We consider only the axial component and ignore the radial component, which is justified for high circulation pump flow rate relative to permeation rate. This leads to a parabolic profile

$${u}_{c} [ \frac{m}{s} ]$$

for the bore side, while for the shell side, we assume the profile to be linear u_{d} i.e.,

$${u}_{c} ( r ) = 2 {\overline{u}}_{c} ( 1 - {( \frac{r}{{r}_{c , m}} )}^{2} ) , 0 \leq r \leq {r}_{c , m}$$

$${u}_{d} ( r ) = {u}_{d , max} ( \frac{r - {r}_{d , m}}{{r}_{a , o} - {r}_{d , m}} ) , {r}_{d , m} \leq r \leq {r}_{a , o}$$

Here, u_{d,max} is the maximum velocity along the void centerline. The diluate side average velocity ū_{d} can then be obtained as

$${\overline{u}}_{d} = \frac{{\int }_{{r}_{d , m}}^{{r}_{a , o}} {u}_{d} ( r ) 2 π rdr}{{\int }_{{r}_{d , m}}^{{r}_{a , o}} 2 π rdr}$$

Ignoring density variation in the transverse direction for simplicity, the average outlet salinities can then be written as

$$\begin{matrix}{C}_{c , out} = \frac{{\int }_{0}^{{r}_{c , m}} C ( r ) {u}_{c} ( r ) 2 π rdr}{{\int }_{0}^{{r}_{c , m}} {u}_{c} ( r ) 2 π rdr} \\ = \frac{{\int }_{{r}_{0}}^{{r}_{c , b}} {C}_{c , b} {u}_{d} ( r ) 2 π rdr + {\int }_{{r}_{c , b}}^{{r}_{c , m}} {C}_{c , bl} ( r ) {u}_{d} ( r ) 2 π rdr}{{\overline{u}}_{c} π {r}_{c , m}^{2}}\end{matrix}$$

$$\begin{matrix}{C}_{d , out} = \frac{{\int }_{{r}_{d , m}}^{{r}_{a , o}} C ( r ) {u}_{d} ( r ) 2 π rdr}{{\int }_{{r}_{d , m}}^{{r}_{a , o}} {u}_{d} ( r ) 2 π rdr} \\ = \frac{{\int }_{{r}_{d , m}}^{{r}_{d , b}} {C}_{d , bl} ( r ) {u}_{d} ( r ) 2 π rdr + {\int }_{{r}_{d , b}}^{{r}_{a , o}} {C}_{d , b} {u}_{d} ( r ) 2 π rdr}{{\overline{u}}_{c} π ( {r}_{a , o}^{2} - {r}_{d , m}^{2} )}\end{matrix}$$

### Pressure

For permeation, the applied pressure needs to exceed the osmotic pressure difference across the active layer of the membrane. The osmotic pressure difference Δπ[bar] is computed by evaluating osmotic pressure as a function of salinity i.e.,

Δπ(t)=π(C_{c,m}(t))−π(Cₛᵤₚ(t)) (11)

The pressure to which the concentrate stream entering the membrane module needs to be brought up to, to sustain the prescribed water flux J_{w} is then calculated using

$${J}_{w} = {A}_{w} {ρ}_{w} ( Δ P ( t ) - Δπ ( t ) ) [ \frac{1 {m}^{3}}{1000 L} ] [ \frac{1 hr}{3600 s} ] \qquad ( 12 )$$

where

$${A}_{w} [ \frac{LMH}{bar} ]$$

is the membrane water permeability coefficient, ρ_{w} is density of pure water and ΔP[bar] is the pressure difference between the concentrate and the diluate side. The applied pressure also needs to compensate for the pressure drop along the longitudinal flow direction on both sides. The pressure drop ΔP, in the concentrate recirculation loop (ignoring losses in connecting pipes) can be computed from Re_{c} assuming laminar flow as

$$Δ {P}_{c} = \frac{64}{{Re}_{c}} \frac{{L}_{fiber}}{{d}_{H , c}} \frac{1}{2} {ρ}_{c , out} {\overline{u}}_{c}^{2} [ \frac{1 bar}{{10}^{5} Pa} ] \qquad ( 13 )$$

The pressure drop in the triangular voids on the diluate side is calculated similar to Equation 13, approximating the cross-section to be circular with diameter d_{H,d}. A conservative estimate of the high-pressure pump outlet pressure P_{HPP} would be

P_{HPP}(t)=ΔP(t)+ΔP_{c}+ΔP_{d} (14)

with ΔP_{c} and ΔP_{d} being compensated by the concentrate and diluate circulation pumps. Equations 11 and 12 indicate that P_{HPP} depends strongly on water flux and stream salinities. As such, the membrane burst pressure which upper bounds P_{HPP} limits the operating flux during a stage.

### Tank Sizing and Diluate Volume Balancing

To simulate batch CFRO, we need to estimate the volume of diluate required at the beginning of each stage that allows us to arrive at a cyclic steady state. Ideally, the diluate volume at the end of each operational stage matches the initial volume of diluate required in the previous operational stage of the next batch. This allows salinities between successive batches to match and avoids mixing between feeds of different salinities.

Let V_{tank,d,k} [m³] be the volume of diluate at the beginning of temporal stage k, k≥1. The diluate volume in the tank and membrane at the end of stage k should be equal to the same at the beginning of the previous stage k−1. We assume ideal flushing under plug flow conditions here, i.e, diluate volumes in the membranes are perfectly swapped between successive stages. Mathematically, this can be written as

V_{tank,d,k-1}+V_{mem,d}=V_{tank,d,}k+V_{mem,d}+V_{p,k} (15)

where V_{p,k} [m³] is the permeation volume during stage k, and along with a constant high-pressure pump flow rate during that stage \dot{V}_{HPP,k} determines the time required tₖ [s] for the same i.e.,

$${t}_{k} = \frac{{V}_{p , k}}{{\dot{V}}_{HPP , k}}$$

Let C_{d,k} be the starting diluate salinity in stage k and ρ_{d,k} be the corresponding density at C_{d,k}, then mass balance for salt after permeation can be written as

ρ_{d,k}(V_{tank,d,k}+V_{mem,d})C_{d,k}+m_{s,k}=ρ_{d,k-1}(V_{tank,d,k-1}+V_{mem,d})C_{d,k-1} (16)

with m_{s,k} [g] being the mass of salt transported across the membrane to the diluate side during permeation in stage k. For any stage, mₛ depends on Jₛ which, for a batch process, varies with time even when J_{w} does not. Consequently, it is difficult to pre-compute and account for it in Equation 16. As such, in our analysis, we consider membranes with sufficiently high salt rejection and set m_{s,k}=0 for tank sizing calculations. With this simplification, Equations 15 and 16 can be recursively solved since V_{tank,d,1} and diluate salinity at end of first stage are prescribed.

For a given value of initial diluate volume for the first stage V_{tank,d,1}, the overall recovery of batch CFRO (BCFRO) RR_{BCFRO}[−] is dictated by the initial concentrate volume V_{tank,c,initial}. The increased recovery of batch CFRO is due to reduction in feed volume for the RO plant supplying brine to the former. The reduction in required feed volume is given as

ΔV_{feed,RO}=V_{tank,d,0}+V_{mem,d}

where V_{tank,d,0} is the volume of diluate in the tank at the end of first stage and can be obtained by solving Equations 15 and 16. Let RR_{RO} be the recovery of the RO plant supplying brine to the batch CFRO system. The volume of feed that the RO plant would ingest to run the batch CFRO system without feed supply from the latter is

$${V}_{feed , RO} = \frac{{V}_{tank , c , initial} + {V}_{mem , c}}{1 - {RR}_{RO}}$$

Then, RR_{BCFRO} can be calculated after offsetting the RO plant feed requirement as

$${RR}_{BCFRO} = \frac{{V}_{p , RO}}{{V}_{feed , RO , net}} = \frac{{V}_{feed , RO} {RR}_{RO}}{{V}_{feed , RO} - Δ {V}_{feed , RO}}$$

where V_{p,RO} is the amount of permeate produced by the RO plant and V_{feed,RO,net} is the net feed volume input to the RO plant. Let V_{tank,c,final} be the volume of concentrate at the end of a batch with salinity C_{c,final}. The batch CFRO process can then be described as a control volume that takes V_{feed,RO,net} at salinity C_{feed,RO} as input and produces V_{c,final} at C_{c,final} and pure water as outputs, where

V_{c,final}=V_{tank,c,final}+V_{mem,c}

We can write conservation of mass of salt for the said control volume as

ρ_{feed,RO}V_{feed,RO,net}C_{feed,RO}=ρ_{c,final}V_{c,final}C_{c,final}

where P_{feed,RO} and ρ_{c,final} are densities at C_{feed,RO} and C_{c,final} respectively. We define RR_{BCFRO} in terms of the said salinities as

$${RR}_{BCFRO} = 1 - \frac{{ρ}_{feed , RO} {C}_{feed , RO}}{{ρ}_{c , final} {C}_{c , final}}$$

For prescribed values of C_{c,final} and V_{tank,c,final}, we can calculate RR_{BCFRO} and more importantly, V_{tank,c,initial} and V_{tank,d,1} to initialize the simulation.

### Energy Consumption

The energy consumption of the high-pressure and circulation pumps can be calculated from the volumetric flow rate and pressure drop across them. A key source of inefficiency can be the pressure exchanger which handles repeated passes of the concentrate stream and is reflected in the concentrate circulation pump work. Let η[−] and Ė [kW] be respectively, the isentropic efficiency and instantaneous power consumption of the pumps, with the subscripts ‘HPP’, ‘CCP’ and ‘DCP’ respectively denoting the high-pressure, concentrate circulation and diluate circulation pumps. The pressure exchanger has an isentropic efficiency η_{PX} and handles the same flow rate as the circulation pump under balanced conditions. The power consumption of each pump can then be written as

$${\dot{E}}_{HPP} ( t ) = \frac{{P}_{HPP} ( t ) {\dot{V}}_{HPP}}{{η}_{HPP}} [ \frac{100 kW}{bar \frac{{m}^{3}}{s}} ]$$

$${\dot{E}}_{CCP} ( t ) = \frac{( {P}_{HPP} ( t ) - {η}_{PX} ( {P}_{HPP} ( t ) - Δ {P}_{c} ) ) {\dot{V}}_{CCP}}{{η}_{CCP}} [ \frac{100 kW}{bar \frac{{m}^{3}}{s}} ]$$

$${\dot{E}}_{DCP} = \frac{Δ {P}_{d} {\dot{V}}_{DCP}}{{η}_{DCP}} [ \frac{100 kW}{bar \frac{{m}^{3}}{s}} ]$$

It should be noted that the pressure drop in the circulation loops can be higher than ΔP_{c} and ΔP_{d} in the presence of flow restrictions, metering devices, pipes, bends and valves. In that case, Equation 13 can be updated to reflect the same, and likewise for the diluate circulation loop.

Let the RO plant that feeds batch CFRO operate at a recovery of RR_{RO} with specific energy consumption

$${SEC}_{RO} [ \frac{kWh}{{m}^{3}} ] .$$

Agnostic of other details of the RO plant, the specific energy consumption of overall batch CFRO system SEC_{BCFRO} can be calculated as

$${SEC}_{BCFRO} = {SEC}_{RO} + \frac{{\int }_{0}^{\sum {t}_{k}} ( {\dot{E}}_{HPP} ( t ) + {\dot{E}}_{CCP} ( t ) + {\dot{E}}_{DCP} ( t ) ) dt}{{V}_{p , RO}} [ \frac{1 h}{3600 s} ]$$

### Results

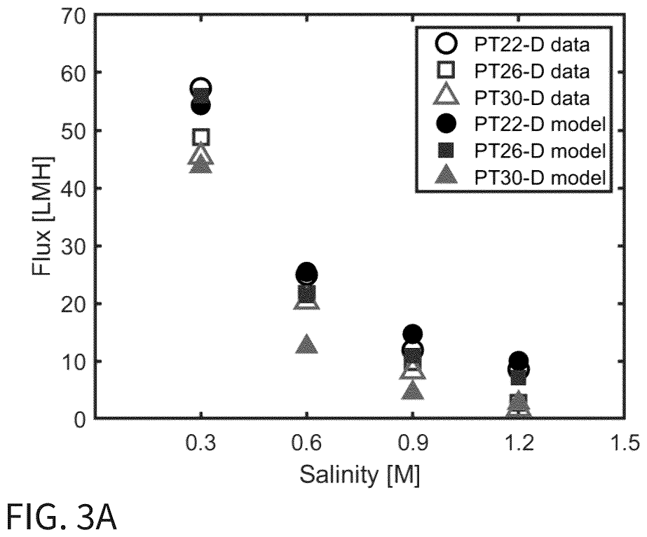

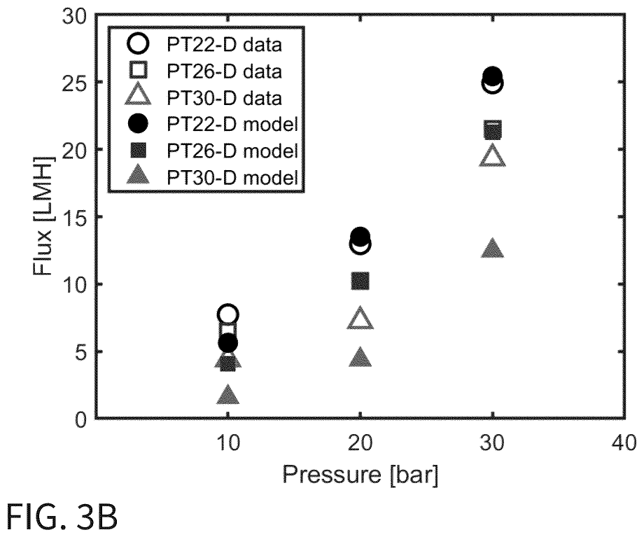

For a single membrane module embodiment and specified process parameters, after optimizing the difference between the volume of diluate produced in different stages while trying to maximize the terminal concentrate salinity, the following performance numbers were obtained. The salinity profiles across the different stages of a cycle are shown in FIG. 3.

One interesting aspect of the present novel technology lies in the system design that converts an unsteady process into a temporally multi-staged, cyclically steady process. Conservation of mass of salt and water applied iteratively at each stage enables calculation of initial tank volumes that ensure cyclic operation. Diluate salinity at the end of the first stage and diluate volume matching between successive stages across batches provide the required constraints for the same. In terms of hardware, the new process can reuse the same apparatus: membranes and flow devices across multiple stages. It certainly involves more valving than a steady state multi-stage process, however, actuating the 3-port-2-way valves is a relatively simple task. Based on the pressure exchanger, atmospheric tank batch RO design is scalable, operationally flexible and easy to construct using off-the-shelf components. The following sections discuss the relevant time profiles for a bench scale system model simulated using parameters listed herein. The module sizing was based on the surface area of the commercial hollow fiber modules which is 76.8 m², but as their active layer faces the shell side, the surface area of the module is recalculated based on the bore side. The initial concentrate and diluate tank sizes at the first stage are determined by choosing the terminal concentrate tank volume at the end of the cycle to be equal to the module volume in the concentrate side. The volumetric flow rate of the circulation pumps is calculated based on 15% recovery ratio per pass in the first stage. The overall process requires 4 stages to dewater the feed up to 194.35 g/kg salinity with water recovery of 84.39%. The total energy consumption for such a process is 4.24 kWh/m³. The minimum reversible specific energy consumption is calculated as 1.77 kWh/m³ using the method introduced in for the process of producing pure water from 35 g/kg stream with brine salinity of 194.35 g/kg. Thus, the second law efficiency of the process is 41.8%. The time-average flux in the cycle is 2.12 LMH.

Membrane properties

Area based on hollow fiber inner diameter,
Aₘₑₘ: 20.53 m²
Water permeability coefficient,
A_{w}: 2.61 LMH/bar
Salt permeability coefficient,
B: 0.0635 LMH
Structural parameter,
S: 802 μm

Process parameters

Water flux
Stage 1: 3.40 LMH
Stage 2: 1.2 LMH
Stage 3: 1.5 LMH
Stage 4: 2 LMH
Concentrate circulation pump flow rate,
V•_{c,out}: 6.59 l/min
Diluate circulation pump flow rate:
V•_{d,in}: 6.59 l/min
High-pressure pump overall efficiency:
η_{HPP}: 80%
Circulation pump overall efficiency:
η_{cP}: 80%
Pressure exchanger overall efficiency:
η_{PX}: 95%

Performance metrics

Overall water recovery,
RRₒᵥₑᵣₐₗₗ: 84.39%
Terminal concentrate salinity,
Cₜₑᵣₘ: 194.35 g/kg
Overall specific energy consumption,
SEC: 4.24 kWh/m³

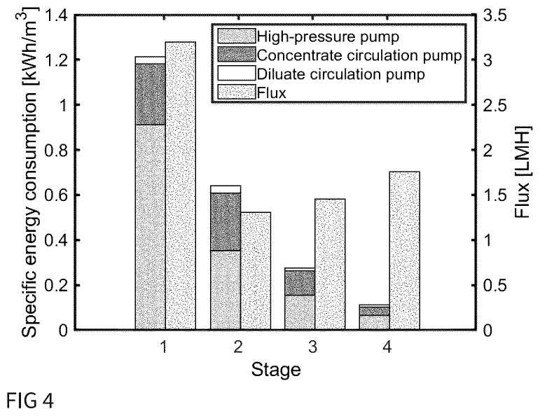

The breakdown of specific energy consumption and flux is given in FIG. 4. The share of energy consumption for the stages are 29%, 15%, 6%, and 3%, respectively for the 4 stages. The remaining energy is consumed in the RO stage. In each BCFRO stage, the HPP dominates the energy consumption which ranges between 55% and 75% of the energy consumed in the stage. Although the volumetric flow rate of high-pressure pump does not exceed 1.16 L/min, which is the HPP flow rate at the first stage, the energy for exerting the high pressure makes the HPP have higher energy consumption than do the circulation pumps. For each of the stages the range of share of energy consumption is between 22% and 40% for the concentrate circulation pump and between 3% and 5% for the diluate circulation pump. The flux of the BCFRO stages are 3.20, 1.30, 1.45, and 1.75 LMH, respectively. The first stage experiences the highest flux, but the proceedings stages have to reduce the flux to control the pressure and concentration polarization.

### Tank Salinity

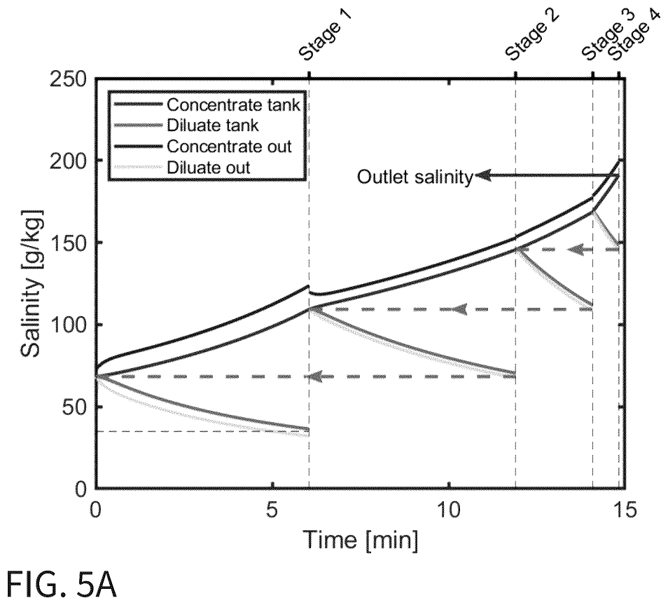

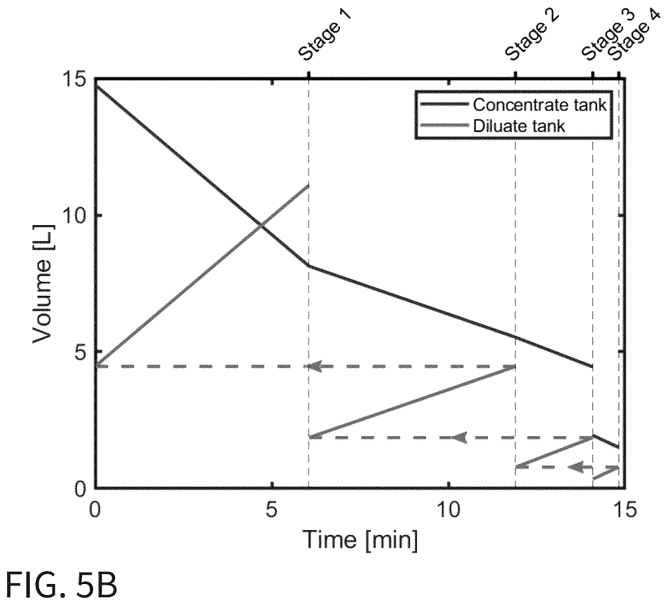

FIG. 5 shows profile of the tank volume and the concentration of the concentrate and diluate streams as a function of time for each temporal stage. The diluate salinity at the end of each stage is matched to the initial diluate salinity used in the previous stage for the next batch. For each stage, one point is split into two lines representing concentrate and diluate salinity profiles. The diluate volumes across stages are matched to a mass balance at the end of each stage, which is advantageous when the rejection is high. However, when the rejection is relatively low, salt transport across the membrane is significant. Such a thing is hard to model with a simple balance, as only the salt permeability coefficient is characterized, and the amount of salt crossing the membrane depends on instantaneous membrane salinity values which change significantly in a batch process. FIG. 5 is obtained using a hypothetical high rejection membrane ( 1/20 of the salt permeability coefficient).

One of the possible ways to accommodate a low rejection membrane is to first obtain a rough estimate salt transport per unit mass of water permeating across the membrane. This estimate can then be used as a feedforward input in the salt mass balance equation, alongside which a feedback controller can tweak the flux to reach the correct terminal diluate salinity and volume. Such an approach requires a time varying flux during a stage and should be covered in future works.

### Membrane Salinity

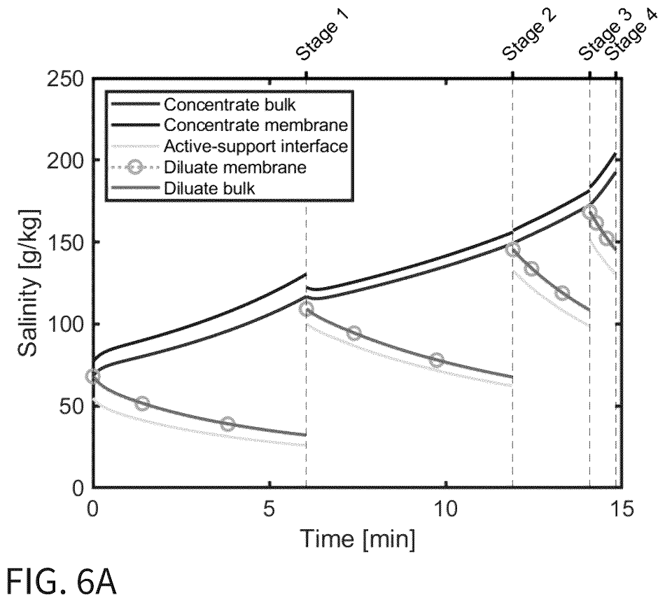

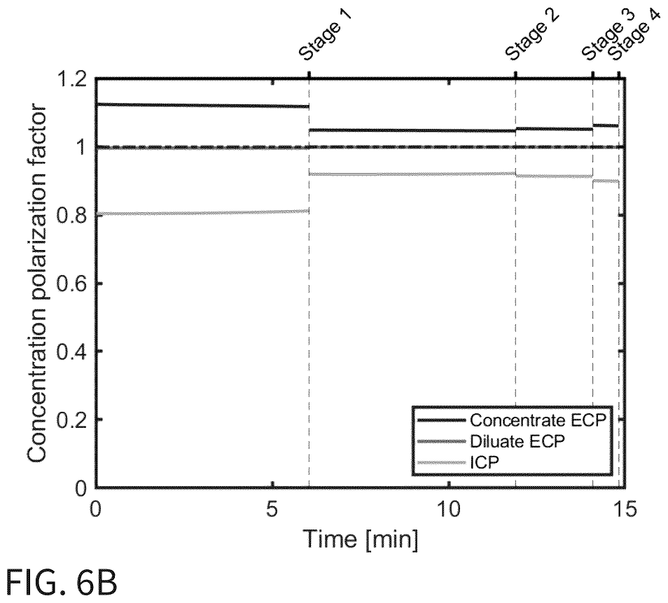

As expected, the model shows that the effect of concentration polarization is most pronounced in the support layer followed by the external concentration polarization on the concentrate side. This is visible through the gaps between these salinity profiles in FIG. 6A. The internal concentration polarization can be quantified by the ratio of the salinity difference across the active layer to that between the bulk streams, and can be named as concentration polarization factor. A thinner support layer implies less internal concentration polarization but also lower terminal pressures. For the streams outside the membrane, the ratio between the bulk salinity and the salinity near the membrane quantify external concentration polarization. External concentration polarization on the diluate side is minimal and can be ignored to simplify the model further (FIG. 6B). Concentration polarization is a strong function of flux, with internal concentration polarization exacerbated by the structural parameter. However, it should be noted that a steady state model has been used to understand concentration polarization which may not be able to capture the dynamics completely. The simplification of the diluate side geometry to an annulus may not be perfect either as seen in FIG. 2.

### Pressure Profile

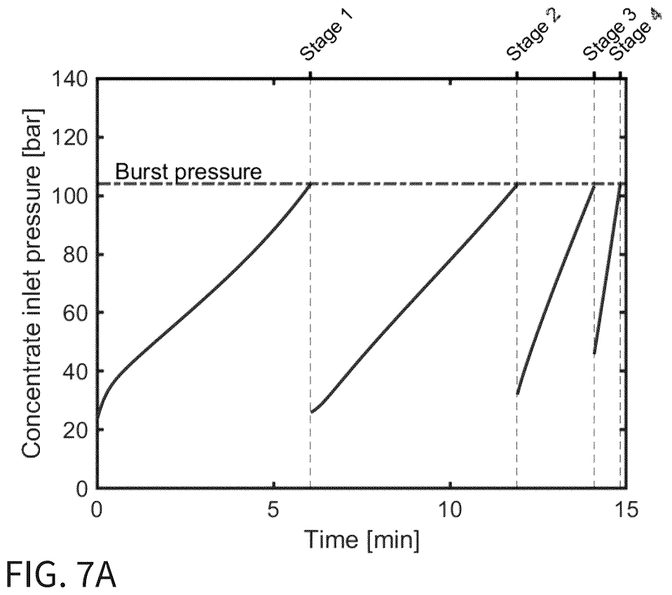

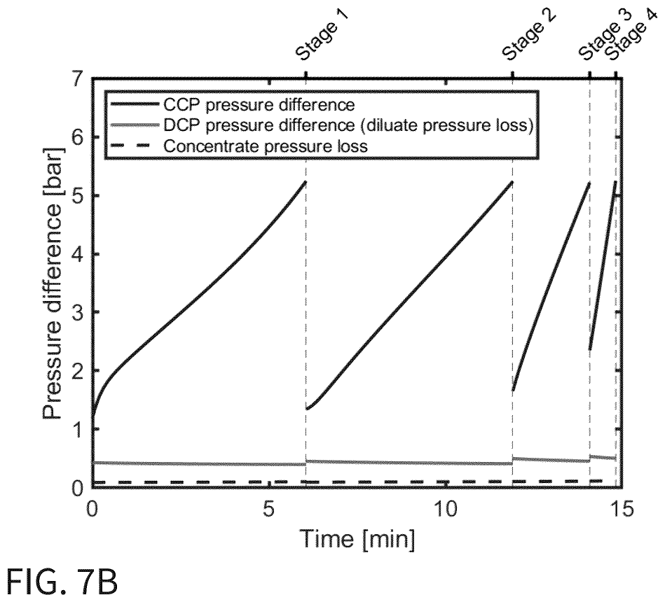

FIGS. 7A-7B shows the profile of concentrate and diluate pressure as well as the pressure difference across the circulation pumps for the system. The flux for the stages is chosen such that the final concentrate inlet pressure at each stage roughly reaches the burst pressure of the membrane (FIG. 7A). The applied hydraulic pressure in a counterflow process overcomes the osmotic pressure difference across the active layer of the membrane to cause permeation. A batch process allows for a lower average pressure during a cycle as compared to a steady state process for the same permeation rate which can help in reducing membrane compaction. The burst pressure of the membrane dictates the terminal pressure and hence the flux that can be sustained during each stage. For membranes with lower burst pressure, a constant flux profile may not be suitable, and it may not be possible to reach an arbitrary terminal salinity. Higher burst pressure, however, comes at the cost of a thicker support layer which increases internal concentration polarization and hence reduces energy efficiency. The pressure drop is calculated based on an average flow rate across the channel. Since, the concentrate and diluate circulation pumps run at the same flow rate, the pressure drops depend solely on the hydraulic diameter of the channel on each side (assuming laminar flow and hydraulic diameter accurately captures the pressure drop). The pressure drop along the concentrate side remains less than 0.13 bar while the pressure drop along the diluate side is between 0.40 and 0.54 bar. With a smaller hydraulic diameter, pressure drop on the diluate is larger than that on the concentrate side. Nonetheless, the CCP has to exert higher pressure difference than the DCP (FIG. 7B) to compensate the loss of the PX. The pressure boost of CCP varies between 1.2 and 5.3 bar. Since circulation pumps usually have a low efficiency, they are spun at a constant speed throughout the batch. The flow rate through the high-pressure pump, which can be very efficient across a wide operating range (axial piston pump for example), is varied to set the desired flux.

### Example

In one embodiment, an assembly for reverse osmotically desalinating water 10 includes a batch counterflow reverse osmosis module 15, which further includes a first high-pressure tank 20 having a first portion 25 and a second portion 30 and a reverse osmosis membrane 35 operationally connected therebetween. A first portion inlet 40 is operationally connected to the first portion 25 and a second portion inlet 45 is operationally connected to the second portion 30. A first portion outlet 50 is operationally connected to the first portion 25 and a second portion outlet 55 is operationally connected to the second portion 30. A first valve 60 is operationally connected having a first first valve inlet 65, a second first valve inlet 70, a first first valve outlet 75 in fluidic communication with the first portion inlet 40 and a second first valve outlet 80 in fluidic communication with the second portion inlet 45. A high-pressure pump 85 is operationally connected to a water source 90 and to the first first valve inlet 65. A second valve 95 having a first second valve inlet 100 in fluidic communication with the first portion outlet 50 and a second second valve inlet 105 in fluidic communication with the second portion outlet 55 and a second valve outlet 110. A second high-pressure tank 115 having a third portion 120 and a fourth portion 125 and a counterflow reverse osmosis membrane 130 operationally connected therebetween is provided. A third portion inlet 135 is operationally connected to the third portion 120 and to the first portion outlet 50 and a fourth portion inlet 140 is operationally connected to the fourth portion 125 and to the second portion outlet 55. A third portion outlet 145 is operationally connected to the third portion 120 and to the second portion 30 and a fourth portion outlet 150 is operationally connected to the fourth portion 125. A third valve 155 is provided having a first third valve inlet 160, a second third valve inlet 165, a first third valve outlet 170 in fluidic communication with the third portion inlet 135 and a second third valve outlet 175 in fluidic communication with the fourth portion inlet 140. A third high-pressure tank 180 is provided having a fifth portion 185 and a sixth portion 190 and a batch counterflow reverse osmosis membrane 195 operationally connected therebetween. A fifth portion inlet 200 is operationally connected to the fifth portion 185 and to the third portion outlet 145 and a sixth portion inlet 205 is operationally connected to the sixth portion 190. A fifth portion outlet 210 is operationally connected to the fifth portion 185 and a sixth portion outlet 215 is operationally connected to the second portion inlet 45 and to the fourth portion inlet 140. A fourth valve 220 is provided having a first fourth valve inlet 225, a second fourth valve inlet 230, a first fourth valve outlet 235 in fluidic communication with the fifth portion inlet 200 and a second fourth valve outlet 240 in fluidic communication with the second portion inlet 45. The feed water source 90 to be desalinated is operationally connected to the batch counterflow reverse osmosis module 15 and a plurality of respective diluent tanks 245 are operationally connected to the batch counterflow reverse osmosis module 15. A circulation pump 250 is operationally connected to the batch counterflow reverse osmosis module 15 and an electronic controller 255 is operationally connected to the respective valves 60, 95, 155 and to the high-pressure pump 85 and to the circulation pump 250. Typically, at least one sensor 260 is operationally connected to the module 15 and to the electronic controller 255.

In operation, the system 10 is exploited by identifying a first tank having a first side, a second side, and a reverse osmosis membrane positioned therebetween; pumping salinated feed water into a first side to yield concentrated saline water in the first side and desalinated water in the second side; identifying a second tank having a third side, a fourth side, and a counterflow reverse osmosis membrane positioned therebetween; pumping concentrated saline water from the first side into the third side to yield concentrated saline water in the third side and diluent in the fourth side; identifying a third tank having a fifth side, a sixth side, and a batch counterflow reverse osmosis membrane positioned therebetween; pumping concentrated saline water from the third side into the fifth side to yield concentrated saline water in the fifth side and diluent in the sixth side; directing diluent from the respective tanks to a desired recovery location; and repeating the above steps.

### Example

In another embodiment, the system 10 includes a seawater source tank 90 having a seawater inlet port 91, a system inlet port 92, and an outlet port 93. The system 10 further includes a tank 115 having a first tank portion 120 and a second tank portion 125 with a RO membrane 130 positioned therebetween. First tank portion 120 includes a first tank portion inlet port 135 and a first tank portion outlet port 145 and second tank portion 125 includes a second tank portion outlet port 150. Outlet port 93 is connected in fluidic communication with inlet port 135. Outlet port 145 is connected in fluidic communication with brine tank 151. System 10 also includes a BCFRO module 15 having a tank body 20 defining a first tank portion 25 and a second tank portion 30 bifurcated by a reverse osmosis membrane 35. First portion includes inlet port 40 and outlet port 50 while second portion 30 includes inlet port 45 and outlet port 55. Inlet port 40 is operationally connected in fluidic communication with high pressure pump 85 and with circulation pump 250. Valve 60 includes first valve inlet 65 connected in hydraulic communication with tank 151, second valve inlet 70, and valve outlet 75 operationally connected in hydraulic communication with high pressure pump 85. A BCFRO storage tank 96 is connected in hydraulic communication with valve inlet 70. Valve 95 includes first valve inlet 100 operationally connected to tank 96, second valve inlet 105 operationally connected to tank 151, and valve outlet 110. A pressure exchanger 265 is connected in hydraulic communication with outlet 110, with circulation pump 250, and with tank 96. Valve 155 includes inlet port 160 connected in hydraulic communication with tank 151, inlet port 165 connected in hydraulic communication with outlet port 50, and outlet port 170 connected in hydraulic communication with pressure exchanger 265. Valve 270 is connected in hydraulic communication between outlet port 55 and tanks 245. Valve 280 is connected in hydraulic communication with tank array 245 and inlet port 92. Valve 290 is connected in hydraulic communication with tank array 245 and pump 300 and pump 300 is connected in hydraulic communication with inlet port 45. Electronic controller 255 is operationally connected to valves 60, 95, 155, 270, 280, 290, pumps 85, 250, 300, and sensors 260.

### Example

A temporally multi-staged assembly for reverse osmotically desalinating water, including a feed water source and a batch counterflow reverse osmosis module operationally connected to the water feed source. The batch counterflow reverse osmosis module includes a first high-pressure tank having a first portion and a second portion and a reverse osmosis membrane operationally connected therebetween, a first portion inlet operationally connected to the first portion and a second portion inlet operationally connected to the second portion, a first portion outlet operationally connected to the first portion and a second portion outlet operationally connected to the second portion, a first valve having a first first valve inlet, a second first valve inlet, a first first valve outlet in fluidic communication with the first portion inlet and a second first valve outlet in fluidic communication with the second portion inlet, a high-pressure pump operationally connected to the source and to the first first valve inlet, a second valve having a first second valve inlet in fluidic communication with the first portion outlet and a second second valve inlet in fluidic communication with the second portion outlet and a second valve outlet, a second high-pressure tank having a third portion and a fourth portion and a counterflow reverse osmosis membrane operationally connected therebetween, a third portion inlet operationally connected to the third portion and to the first portion outlet and a fourth portion inlet operationally connected to the fourth portion and to the second portion outlet, a third portion outlet operationally connected to the third portion and to the second portion and a fourth portion outlet operationally connected to the fourth portion, a third valve having a first third valve inlet, a second third valve inlet, a first third valve outlet in fluidic communication with the third portion inlet and a second third valve outlet in fluidic communication with the fourth portion inlet, a third high-pressure tank having a fifth portion and a sixth portion and a batch counterflow reverse osmosis membrane operationally connected therebetween, a fifth portion inlet operationally connected to the fifth portion and to the third portion outlet and a sixth portion inlet operationally connected to the sixth portion, a fifth portion outlet operationally connected to the fifth portion and a sixth portion outlet operationally connected to the second portion inlet and to the fourth portion inlet, a fourth valve having a first fourth valve inlet, a second fourth valve inlet, a first fourth valve outlet in fluidic communication with the fifth portion inlet and a second fourth valve outlet in fluidic communication with the second portion inlet. A plurality or respective diluent tanks are operationally connected to the batch counterflow reverse osmosis module. A circulation pump is operationally connected to the batch counterflow reverse osmosis module and an electronic controller is operationally connected to the respective valves and to the high-pressure pump and to the circulation pump.

### CONCLUSION

Combating water scarcity while controlling the impact of wastewater and on the ecosystem and energy demand requires innovative approaches in membrane-based, non-thermal methods for reaching zero liquid discharge desalination. Herein, the configuration of batch reverse osmosis with pressure exchanger is expanded to temporally multistage batch counterflow reverse osmosis to reach high water recovery. The process is accomplished by connecting multiple atmospheric tanks to store intermediary-produced diluate volumes from a single batch CFRO to devise a cyclic process through which the seawater with 35 g/kg salinity is dewatered with 84.39% water recovery. The freshwater is produced using a complementary batch RO process that dewaters the diluate produced in the batch CFRO unit. The system was simulated using reduced order nodal model and the process properties were chosen based on the practical process properties of a hollow fiber membrane in terms of burst pressure. The results showed that the process can be accomplished using four temporal stages with overall average flux of 2.12 LMH, and the specific energy consumption is 4.2 kWh/m³ which correspond to the second law efficiency of 42.5%.

The above examples relate to the first temporally multi-staged batch process that is capable of handling high salinity feeds and attaining high recoveries while using the same membrane module, pumps and pressure exchanger. The specific energy consumption of was 21.2 kWh/m³, an unusually high value for an osmotically assisted RO process, owing to the extremely high pressure drop in the hollow fiber membranes (~10 bar) that need to sustain high flow rates. This high pressure drop also leads to a much faster pressure rise in the system and consequently early termination of a stage. This indicates that the selected hollow fiber membranes and module lengths used in the above examples may not be the best fit for multi-stage batch CFRO. Theoretically, the performance could get much closer to theoretical piston-tank batch CFRO design, whose models predicted an SEC of 1.95 kWh/m³ for 62% recovery of seawater. There is room for substantially more optimization, including module length, fiber diameter, membrane structural parameter, and/or any enhanced-mixing methods. Additionally, some embodiments would benefit from using specially designed spiral wound membranes that offer a large flow area without significant confinement to reduce the pressure drop.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A temporally multi-staged assembly for reverse osmotically desalinating water, comprising:
a feed water source; and
a batch counterflow reverse osmosis module operationally connected to the water feed source and further comprising:
a first high-pressure tank having a first portion and a second portion and a reverse osmosis membrane operationally connected therebetween;
a first portion inlet operationally connected to the first portion and a second portion inlet operationally connected to the second portion;
a first portion outlet operationally connected to the first portion and a second portion outlet operationally connected to the second portion;
a first valve having a first first valve inlet, a second first valve inlet, a first first valve outlet in fluidic communication with the first portion inlet and a second first valve outlet in fluidic communication with the second portion inlet;
a high-pressure pump operationally connected to the source and to the first first valve inlet;
a second valve having a first second valve inlet in fluidic communication with the first portion outlet and a second second valve inlet in fluidic communication with the second portion outlet and a second valve outlet;
a second high-pressure tank having a third portion and a fourth portion and a counterflow reverse osmosis membrane operationally connected therebetween;
a third portion inlet operationally connected to the third portion and to the first portion outlet and a fourth portion inlet operationally connected to the fourth portion and to the second portion outlet;
a third portion outlet operationally connected to the third portion and to the second portion and a fourth portion outlet operationally connected to the fourth portion;
a third valve having a first third valve inlet, a second third valve inlet, a first third valve outlet in fluidic communication with the third portion inlet and a second third valve outlet in fluidic communication with the fourth portion inlet;
a third high-pressure tank having a fifth portion and a sixth portion and a batch counterflow reverse osmosis membrane operationally connected therebetween;
a fifth portion inlet operationally connected to the fifth portion and to the third portion outlet and a sixth portion inlet operationally connected to the sixth portion;
a fifth portion outlet operationally connected to the fifth portion and a sixth portion outlet operationally connected to the second portion inlet and to the fourth portion inlet;
a fourth valve having a first fourth valve inlet, a second fourth valve inlet, a first fourth valve outlet in fluidic communication with the fifth portion inlet and a second fourth valve outlet in fluidic communication with the second portion inlet; and
a plurality or respective diluent tanks operationally connected to the batch counterflow reverse osmosis module.

2. The temporally multi-staged assembly for reverse osmotically desalinating water of claim 1, and further comprising:
a circulation pump operationally connected to the batch counterflow reverse osmosis module; and
an electronic controller operationally connected to the respective valves and to the high-pressure pump and to the circulation pump.

3. A temporally multi-staged method for desalinating water, comprising:
a) identifying a first tank having a first side, a second side, and a reverse osmosis membrane positioned therebetween;
b) pumping salinated feed water into a first side to yield concentrated saline water in the first side and desalinated water in the second side;
c) after b), identifying a second tank having a third side, a fourth side, and a counterflow reverse osmosis membrane positioned therebetween;
d) pumping concentrated saline water from the first side into the third side to yield concentrated saline water in the third side and diluent in the fourth side;
e) after d), identifying a third tank having a fifth side, a sixth side, and a batch counterflow reverse osmosis membrane positioned therebetween;
f) pumping concentrated saline water from the third side into the fifth side to yield concentrated saline water in the fifth side and diluent in the sixth side;
g) directing diluent from the respective tanks to a desired recovery location; and
h) repeating steps a-g) at least once.

4. A temporally multi-staged counterflow reverse osmosis process for desalinating water, comprising:
i) identifying a first tank defining a first tank portion, a second tank portion, and a reverse osmosis membrane operationally connected therebetween;
j) pumping salinated feed water into a first side to yield brine in the first side and desalinated water in the second side;
k) identifying a second tank defining a third portion, a fourth portion, and a counterflow reverse osmosis membrane operationally connected therebetween;
l) after j), pumping brine from the first portion into the third portion to yield brine in the third portion and diluent in the fourth portion;
m) identifying a third tank defining a fifth portion, a sixth portion, and a batch counterflow reverse osmosis membrane operationally connected therebetween;
n) after l), pumping brine from the third side into the fifth portion to yield brine in the fifth portion and diluent in the sixth portion;
o) directing diluent from the respective tanks to a desired recovery location; and
p) repeating steps a-g) at least once.

5. A temporally staged process for desalinating water, comprising:
q) connecting each side of a reverse osmosis membrane having a first side that loses water and a second, oppositely disposed side that gains water to at least one respective recirculation tank, wherein the at least one respective recirculation tank connected to the first side collects concentrated brine and the at least one respective recirculation tank connected to the second side collects diluate;
r) pumping brine into contact with the first side;
s) collecting diluate at seawater salinity in the at least one respective recirculation tank connected to the second side;
t) collecting concentrated brine in the at least one respective recirculation tank connected to the first side;
u) after s) and t), pumping diluate into contact with the first side; and
v) collecting concentrated brine in the at least one respective recirculation tank connected to the first side.

6. The temporally staged process of claim 5, wherein the respective recirculation tank sizes may be small enough so as to mimic semi-batch and closed-circuit operation.
